(19) United States
(12) Patent Application Publication
(10) Pub. No.: US 2022/0317597 A1
(43) Pub. Date: Oct. 6, 2022

(54) LIQUID PRINTING MATERIAL CONDUIT

(71) Applicant: Hewlett-Packard Development Company, L.P., Spring, TX (US)

(72) Inventors: Ziv Seemann, Nes Ziona (IL); Alexander Yekymov, Nes Ziona (IL); Yuri Drutman, Nes Ziona (IL); Yinon Harari, Nes Ziona (IL); Shmuel Borenstain, Nes Ziona (IL)

(73) Assignee: Hewlett-Packard Development Company, L.P., Spring, TX (US)

(21) Appl. No.: 17/634,161

(22) PCT Filed: Oct. 16, 2019
(86) PCT No.: PCT/US2019/056554

§ 371 Date: Feb. 9, 2022

(51) Int. Cl. G03G 15/11

(52) U.S. Cl. CPC G03G 15/11; G03G 2215/0658

(57) ABSTRACT

In one example, a conduit for returning liquid printing material to a liquid printing material storage tank in a printer comprises a first tubular section and a second section for receiving a flow of liquid printing material from the first tubular section. The second section is arranged to convert the flow of liquid material received from the first section into a falling liquid curtain of liquid printing material that is output from the second section to flow to the liquid printing material tank.

### BACKGROUND

Printers that include binary printing fluid developer units include systems that circulate printing fluid, for example liquid ink, around the printer system from printing fluid tanks to the binary printing fluid developer units.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1A is an example schematic diagram of a printing arrangement.

FIG. 1B. is an example schematic diagram of a print system comprising the print arrangement of FIG. 1A.

FIG. 2 is a schematic diagram of an example conduit for liquid printing material when viewed from a first position.

FIG. 3A is a schematic diagram of an example conduit for liquid printing material when viewed from a second position.

FIG. 3B is a schematic diagram of an example conduit for liquid printing material when viewed from a third position.

FIG. 4A is a schematic diagram of an example conduit for liquid printing material when viewed from above.

FIG. 4B is a schematic diagram of an example conduit for liquid printing material when view from below.

FIG. 5 is a schematic diagram showing a cross section of an example conduit for liquid printing material.

FIG. 6 is a schematic diagram showing a cross section and liquid printing material flow according to the examples of FIGS. 1-4.

### DETAILED DESCRIPTION

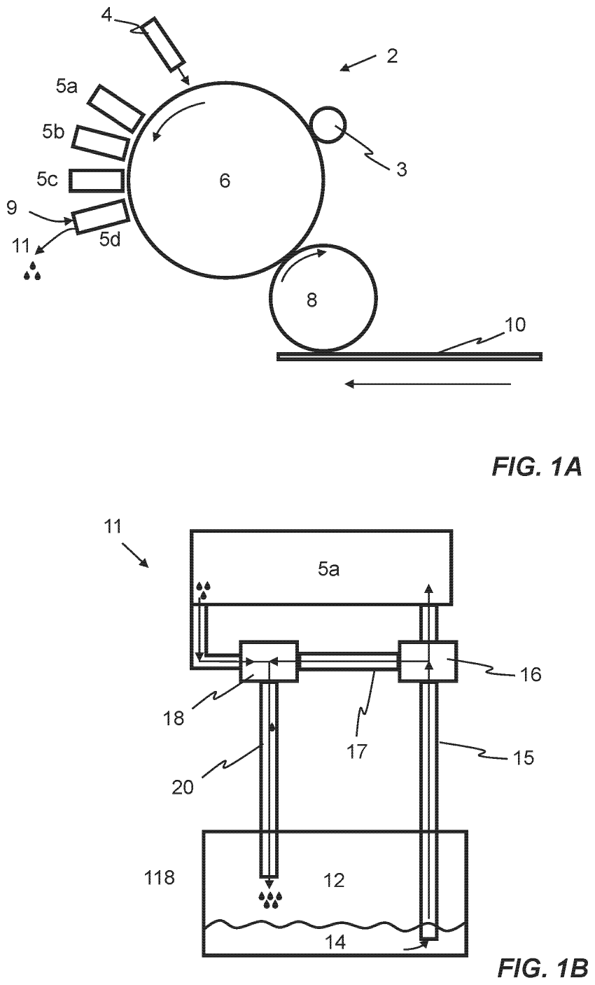

FIG. 1A. is an example of a printing arrangement 2 comprising a photoreceptor (not shown) mounted on imaging drum 6. A charge roller 3 may be provided to induce a uniform electrostatic charge on the photoreceptor that is mounted on imaging drum 6. There may also be provided a writing head, such as a laser 4, to selectively remove the electrostatic charge that has been induced on the photoreceptor mounted on imaging drum 6. The remaining electrostatic charge forms an image that is to be printed. Binary ink developers (BIDs) 5a-d may develop the image over the surface of the imaging drum 6. Here four BIDS are shown, each one representing an individual color, but it will be appreciated that additional BIDs corresponding to additional colors may be used. The image on the image drum 6 is then transferred to an intermediate transfer drum 8 and then onto print media 10.

During this example process, the BIDs 5a-d will be supplied with liquid printing material from liquid printing material tanks (not shown in FIG. 1A). Liquid printing material may come in and out of the BIDs in a continuous cycle and is represented by the arrows 9 and 11 respectively.

A schematic drawing of an example print system 11 is shown in FIG. 1B. The print system 11 may be part of a printer that also comprises the printing arrangement of FIG. 1A. The print system 11 may comprise a plurality of liquid printing material tanks 12 of which one is illustrated in FIG. 1B. The liquid printing material tank 12 contains liquid printing material 14. In use, liquid printing material 14 is cycled through the print system 11 from the liquid printing material tank 12 to a respective one of the BIDS 5a-5d of the printing arrangement 2, in this example the BID 5a, and excess liquid printing material 12 is returned to the liquid printing material tank 12 from the BID 5a. In this example, each one of the BIDs 5a-5d is for printing a different color and so it should be appreciated there will be a separate liquid printing material tank for each BID 5a-5d although for simplicity the tank 12 for the BID 5a is shown alone.

In use, liquid printing material 14 is initially pumped up from the liquid printing material storage tank 12 via a pipe 15 to a valve 16. The valve 16 may be arranged so that, in a printing mode, the liquid printing material is pumped towards the BID 5a in the printing arrangement 2 or, in a printing preparation mode, the liquid printing material is pumped back into the liquid printing material tank 12 along a bypass 17, valve or junction 18 and return tube 20. The reason for the printing preparation mode is to circulate the liquid printing material around the bypass 17 and back to the liquid printing material tank 12 to prepare the liquid printing material for printing and to reduce the amount of bubbles in the liquid printing material tank 12. In print mode, the liquid printing material is circulated through the printing arrangement 2 and the BID 5a. Any excess liquid printing material from the BID 5a is returned through the valve or junction 18 and return tube 20 to the liquid printing material tank 12. The returning liquid printing material 14 is deposited back into the liquid printing material tank 12 under the action of gravity.

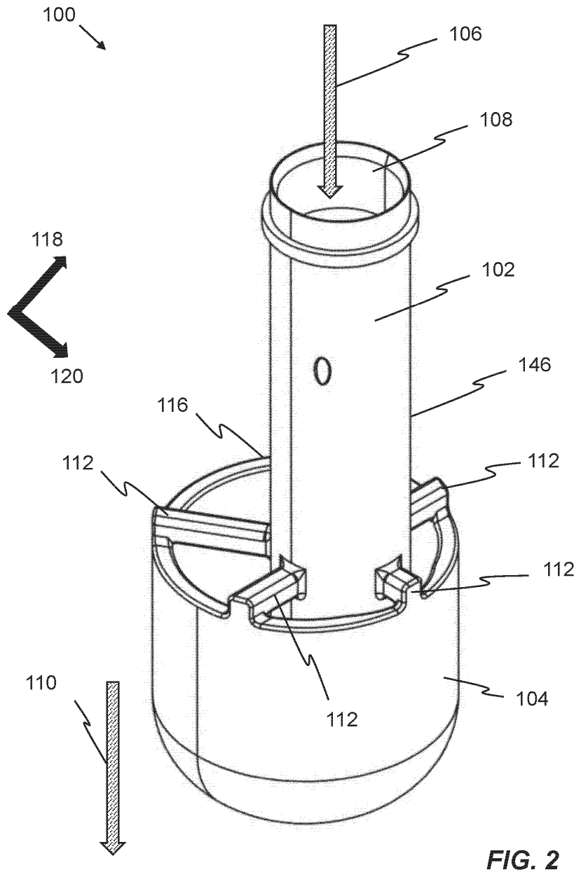

An example of a device 100 to reduce the formation of bubbles in the print system 11 is illustrated in FIG. 2. During the ink cycle, there are many points where bubbles may be formed and circulated through the system. This can result in areas on the print media 10 with no ink which can impact the final print quality and as such there is a need to reduce the formation of bubbles. This device may be mounted on the end of the return tube 20 shown in FIG. 1B. The device, a liquid printing material conduit 100, may comprise a first tubular section 102 and a second section 104 for receiving a flow of liquid printing material from the first tubular section 102. The first tubular section 102 receives returning liquid printing material 106 through a first end 108 and acts as a conduit for the liquid printing material 106.

The first tubular section 102 may be cylindrical in shape extending from the first end 108 to a second end (not visible in FIG. 2). The diameter of the first tubular section 102 may match the diameter of the existing drainpipe 20 and therefore can be added to the drainpipe 20 without needing to adapt the print system 11. It will be appreciated that any cross section other than circular could be used to form the first tubular section 102, for example, square, hexagonal, oval and the like.

The second section 104 in the example of FIG. 2 is a receptacle, for example a bowl like structure, arranged to receive the liquid printing material from the first tubular section 102. The second section 104 is located above the liquid level of the liquid printing material storage tank 12. The second section 104 is arranged to convert a flow of liquid printing material received from the first tubular section 102 into a falling liquid curtain of printing material (as indicated by arrow 110) that is output from the second section 104 into the liquid printing material tank 12. In this example, the falling liquid curtain of printing material is formed when liquid printing material which has collected in the second section 104 overflows from an upper rim 116 of the second section 104. The liquid curtain of printing material falls under the action of gravity and enters the liquid printing material tank 12 smoothly thereby minimizing the disturbance of liquid printing material in the liquid printing material tank 12 and hence minimizing the formation of bubbles in the liquid printing material in the liquid printing material storage tank 12.

In this example, the first tubular section 102 and second section 104 are formed as a single construction. Horizontal connectors 112 extend tangentially from the upper rim 116 of the second section 104 inwardly to connect to an outer surface 146 of the first tubular section 102. In this example, the horizontal connectors 112 are perpendicular to the outer surface 146 of the first tubular section 102 and an outer surface of the second section 104. In other examples these connection angles may be different to perpendicular.

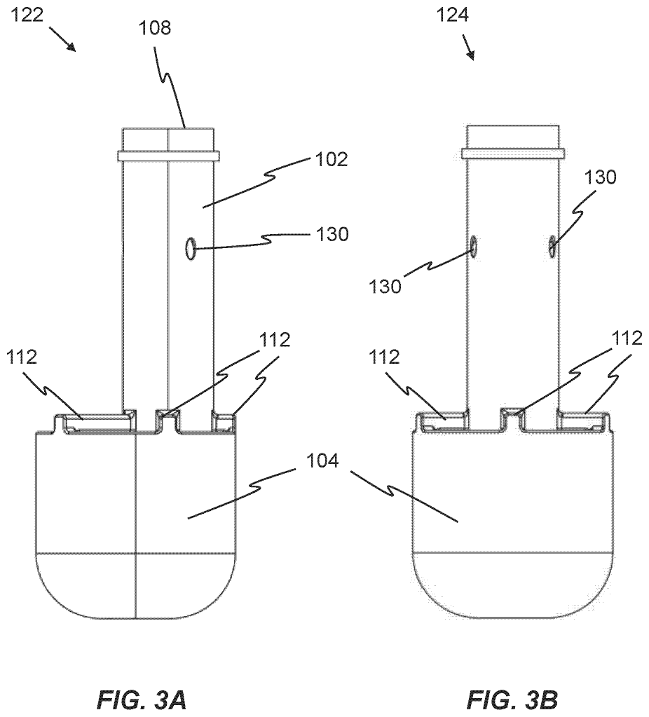

FIG. 3A and FIG. 3B are two schematic drawings illustrating the liquid printing material conduit 100 when viewed in the directions indicated by arrows 118 and 120 respectively in FIG. 2. FIG. 3A and FIG. 3B illustrate that one or more ventilation holes 130 are provided in the first tubular section 102. The purpose of the one or more ventilation holes 130 is to allow any air that has built up in the printing system 11 to be vented. The one or more ventilation holes may be substantially cylindrical in cross section. There may be times when the returning liquid printing material 106 exits through the one or more ventilation holes 130. This may cause the liquid printing material to drop into the liquid printing material tank from a height such that its velocity increases above the point where bubbles are formed. This is undesirable and as such in some examples the vent holes 130 are angled downwardly towards the lower end of the first tubular section 102. This causes the flow of any accidental ventilation of liquid printing material to adhere to the its outer surface of the first tubular section 102 and hence fall into the second section 104.

For this reason, the one or more ventilation holes 130 in the example schematics 122 and 124 appear oval in shape when viewed at a perpendicular angle. This is due to the downward angle at which they are directed.

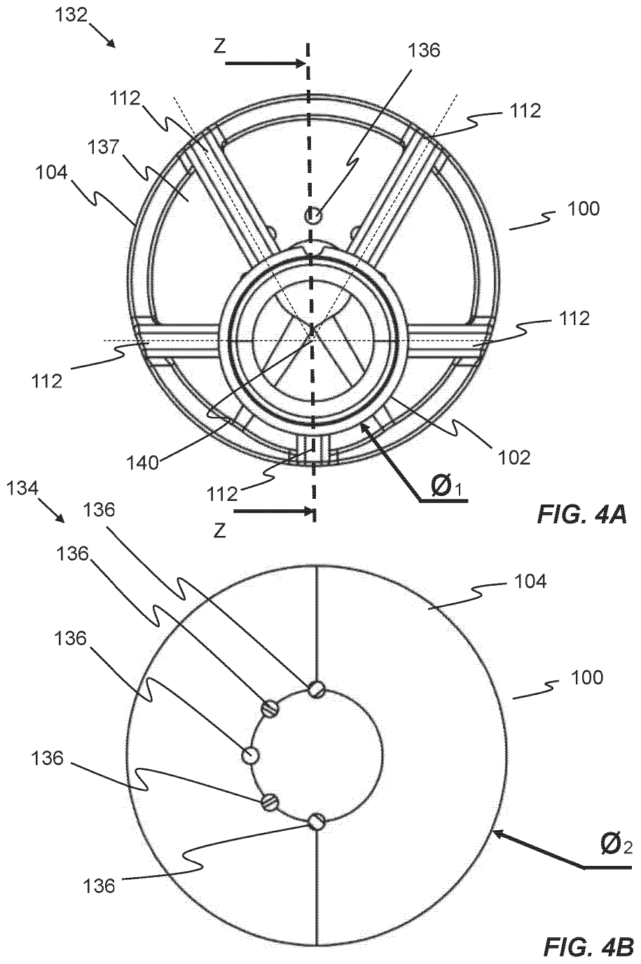

FIG. 4A and FIG. 4B are two schematic drawings illustrating the liquid printing material conduit 100 when viewed from above and below respectively. In addition to the features described above, the liquid printing material conduit 100 may comprise one or more drain holes 136 formed in the second section 104. In this example, there are five drain holes 136 which are disposed radially about the center of a base part 137 of the second section 104 and which extend completely through the base part 137. As such, a small amount of liquid printing material can flow into the liquid printing material tank 12 through the one or more drain holes 136 to enable the second section 104 to completely drain of liquid printing material when the print system 11 is not in operation. This enables operators to remove the second section 104 from the print system 11 for maintenance or replacement without spilling liquid printing material from the second section 104.

Of course, the one or more drain holes 136 may be disposed anywhere in the bottom of the second section 104. They may also be situated above the lowest point of the second section 104 to maintain some of the liquid printing material when the flow of returning liquid printing material 106 stops.

The first tubular section 102 and second section 104 have diameters Ø1 and Ø2 respectively. In this example, the diameter of the second section 104 is larger than the diameter of the first tubular section 102. This results in the flow rate of the liquid print material out of the second section 104 being less than the flow rate of the liquid print material in the first tubular section 102. This reduction in flow rate helps inhibit the formation of bubbles in the liquid printing material tank 12.

As best seen in FIG. 4A, in this example, the first tubular section 102 and second section 104 are not concentrically aligned. This is so that the conduit can fit into the existing print systems. Additionally, this arrangement may ensure that the returning flow of liquid printing material from the first tubular section does not enter the second section 104 directly above the one or more drain holes 136 which helps minimize the velocity at which liquid printing material drains from the drain holes 136. Again, this may reduce the number of bubbles formed in the liquid printing material tank 12.

As is also best seen in FIG. 4A, the five horizontal connectors 112 are arranged about the central axis 140 of the first tubular section 102. This is one example of many arrangements that could be used to connect the first tubular section 102 to the second tubular section 104 and less or more than five connectors may be used.

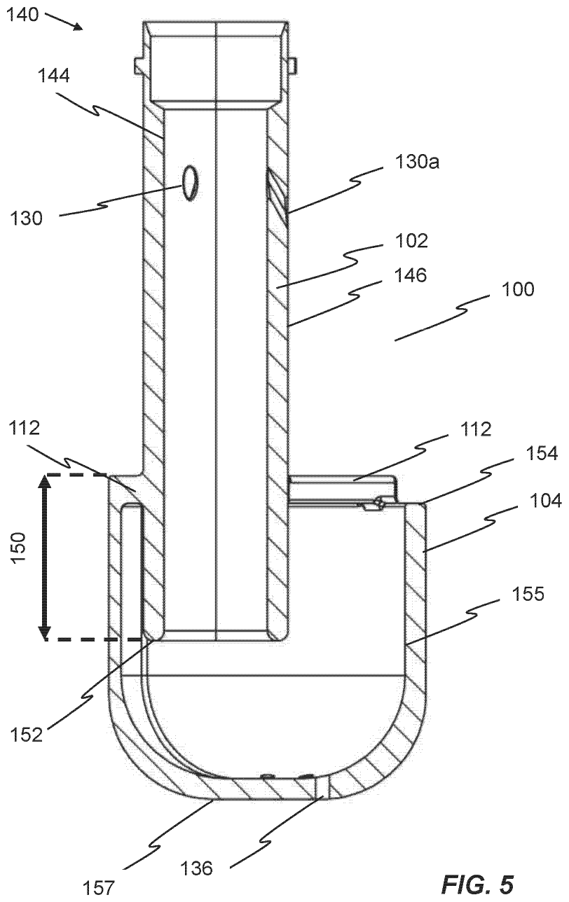

FIG. 5 is a schematic cross-sectional view of the example conduit 100. This view best illustrates the angle at which the one or more ventilation holes 130 are formed in the first tubular section 102. It can be seen that the example ventilation hole 130a is a substantially cylindrical hole that is angled downwardly towards the second section 104 from the inner surface 144 to outer surface 146 of the first tubular section 102. As previously described, this causes the flow of any liquid printing material that accidentally passes through the ventilation hole 130a to adhere to the outer surface of the first tubular section 102 and drain into the second section 104.

FIG. 5 illustrates that the one or more drain holes 136 extend from the inner surface 155 to the outer surface 157 of the base of the second section 104. In this example, the drain hole 136 are generally cylindrical and extend perpendicular to the inner surface 155 of the second section 104. However, any other angle or shape such that liquid printing material can flow out of the second section 104 may be used for the drain holes 136.

FIG. 5 also shows that the first tubular section 102 extends inwardly to the second section 104 leaving an overlap 150 between the lower end 152 of the first tubular section 102 and the upper rim 116 154 of the second section 104. This reduces the turbulence in the liquid printing material and increases the smooth transfer of liquid printing material from the second section 104 to the liquid printing material tank 12. Therefore, the overlap 150 helps to reduce the bubbles formed in the print system.

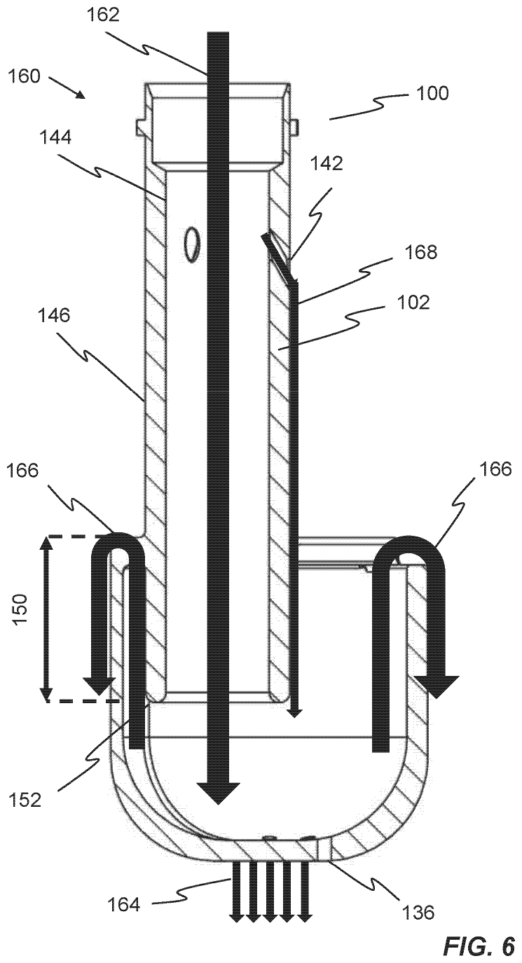

FIG. 6 shows a similar view of the conduit 100 as FIG. 5 but includes additional arrows representing the different flow paths of liquid printing material according to this example. Arrow 162 represents the returning liquid printing material 106 that enters the first end 108 of the first tubular section 102 and enters the second section 104 with a certain flow speed. Immediately the liquid printing material will flow from the second section 104 through the one or more drain holes 136 into the liquid printing material tank. This is indicated by the arrows 164.

The flow 164 of the liquid printing material out of the second section 104 through the one or more drain holes 136 is less than the flow into the second section 104 from the first tubular section 102. This means that when liquid printing material flows from the first tubular section 102 into the second section 104, the second section 104 fills with liquid printing material despite the one or more drain holes 136 in the bottom. The larger diameter Ø2 of the second section 104 ensures that when the liquid printing material overflows 166 it will be at a flow rate that is lower than the flow rate 162 input to the second section 104. This reduces the velocity of the liquid printing material as it enters the liquid printing material tank 12 and thus reduces the amount of bubbles formed in the liquid printing material. Moreover, as described above, the liquid printing material that overflows the upper rim 116 of the second section 104 will fall under the action of gravity in the form of a falling liquid curtain 166. This falling liquid curtain 166 enters the liquid printing material tank smoothly and does not greatly disturb the liquid printing material in the tank which reduces the tendency of bubbles to form.

Generally, the liquid curtain 166 is an uninterrupted and smooth flow of liquid print material. In this example, the generated liquid curtain 166 has a width that extends around the circumference of the rim 116 of the second section 104. It also has a height that extends from the rim 166 to the surface of the liquid printing material in the liquid printing material tank. Finally, the liquid curtain 166 has a thickness extending outwardly from the outer surface 157 of the second section 102. The thickness of the liquid curtain is smaller than its width or height and may be described as a thin ‘film’ or ‘sheet’ of liquid printing material.

The one or more air ventilation holes 130 enable plugs of air in the system to be vented. However, as already mentioned, some liquid print material may escape through the one or more ventilation holes 130. This flow of liquid print material is represented by the arrow 168. Due to the angle of the cylindrical vents 130, the flow 168 adheres to the outer surface 146 of the first tubular section 102 and slowly falls under the action of gravity into the second section 104. Again, this is to reduce the likelihood that air bubbles in the liquid print material are formed. The liquid printing material then joins the flow 166 out of the second section 104 to form the liquid curtain.

Throughout the description the example conduit 100 has been described for use with liquid printing material. It should be understood that any liquid printing material may be used, for example, ink, water, pigment, dye, gel inks, liquid rubber cement etc.

The first tubular section 102 and second section 104 have been described being formed as a single construction joined by one or more horizontal connectors. In other examples, it may be that they are two separate devices. For example, the second section may be formed as part of the liquid printing material tank and the existing conduit fills into it. This will achieve the same result of reducing the amount of bubbles formed.

The first tubular section 102 and second section 104 may be constructed using a variety of materials. Some examples are plastic, metal, concrete, ceramic, soft and hard rubber.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A conduit for returning liquid printing material to a liquid printing material storage tank in a printer, the conduit comprising:
a first tubular section; and
a second section for receiving a flow of liquid printing material from the first tubular section, wherein the second section is arranged to convert the flow of liquid material received from the first section into a falling liquid curtain of liquid printing material that is output from the second section to flow to the liquid printing material tank.

2. A conduit according to claim 1, wherein the second section is a receptacle that receives the flow of liquid material from the first section and which converts the flow of liquid material into the falling liquid curtain by liquid material received in the receptacle overflowing from the receptacle.

3. A conduit according to claim 1, wherein the diameter of the first tubular section is less than a diameter of the second section.

4. A conduit according to claim 1, wherein the tubular section extends inwardly into the second section.

5. A conduit according to claim 1, wherein the first tubular section comprises one or more air vent holes arranged such that if any returning liquid printing material passes through the one or more air vents, the liquid printing material flows down the outside of the first tubular section.

6. A conduit according to claim 1, wherein the second section further comprises one or more drain holes so that the second section drains when not in use.

7. A conduit according to claim 6, wherein the flow of liquid printing material from one or more drain holes in the second section is lower than the inward flow of liquid printing material from the first tubular section.

8. A conduit according to claim 1 wherein, the second section is part of the liquid printing material tank.

9. A conduit according to claim 1, wherein the conduit is constructed of any of the following: metal, plastic, concrete, ceramic, soft and hard rubber.

10. A conduit according to claim 1, wherein the flow of liquid printing material is induced gravitational flow.

11. A conduit according to claim 1, wherein the first tubular section and the second section are a single construction.

12. A conduit according to claim 11, wherein the first tubular section and the second section are joined to form the single construction by one or more connectors.

13. A conduit according to claim 1, wherein the second section is a bowl-like shape.

14. A conduit for liquid printing material comprising:
a first section to receive a flow of liquid printing material, the first section having a first diameter;
a second section to receive and store the flow of liquid printing material from the first section, the second section having a second diameter larger than the first diameter of the first section; and
wherein the second section is arranged to overflow with the liquid printing material.

15. A printing arrangement comprising the conduit according to claim 1.
